(19) United States
(12) Patent Application Publication
(10) Pub. No.: US 2026/0330064 A1
(43) Pub. Date: Oct. 22, 2026

(54) METHOD FOR STORING MODIFIABLE INFORMATION IN A SECURE MANNER AGAINST FALSIFICATION, METHOD FOR CHECKING THE ANTI-FALSIFICATION SECURITY OF INFORMATION, AND DEVICE

(71) Applicant: PAUL BINDER, MUENCHEN (DE)

(72) Inventor: PAUL BINDER, MUENCHEN (DE)

(21) Appl. No.: 19/105,825

(22) PCT Filed: Aug. 24, 2023
(86) PCT No.: PCT/DE2023/200173

§ 371 Date: Feb. 24, 2025

(30) Foreign Application Priority Data
Aug. 25, 2022 (DE) 10 2022 121 572.5

(51) Int. Cl. G06F 21/64; G06T 7/00

(52) U.S. Cl. CPC G06F 21/64; G06T 7/0002

(57) ABSTRACT

A method for storing a modifiable information in a secure manner against falsification. The method includes displaying the first data set on an initial display device so as to display a first optical image of the first data set, displaying the first modified data set on a first display device so as to display a first modified optical image of the first modified data set, superimposing the first optical image with the first modified optical image so as to provide a first superimposed optical image, generating a first superimposed hologram of the first superimposed optical image, and storing the first superimposed hologram so as to provide a first stored hologram. The modifiable information is stored in the secure manner against falsification via the first stored hologram.

### CROSS REFERENCE TO PRIOR APPLICATIONS

This application is a U.S. National Phase application under 35 U.S.C. § 371 of International Application No. PCT/DE2023/200173, filed on Aug. 24, 2023 and which claims benefit to German Patent Application No. 10 2022 121 572.5, filed on Aug. 25, 2022. The International Application was published in German on Feb. 29, 2024 as WO 2024/041708 A 1 under PCT Article 21(2).

### FIELD

The present invention relates to a method for storing modifiable information in a secure manner against falsification via a continuously expandable data volume of superimposed data sets, wherein a first data set contains the modifiable information, and a first modified data set contains first modified information, and the first data set and the first modified data set are stored in a superimposed manner, so that the first data set and the modified data set are stored in a superimposed manner so as to be trackable in the continuously expandable data volume. The present invention further relates to a method for checking, on the basis of a respective hologram, the anti-falsification security of information, wherein the information has in particular been stored in a secure manner against falsification via the above method. The present invention additionally relates to a device for carrying out such methods.

### BACKGROUND

Previously known methods for storing modifiable information in a secure manner against falsification using, for example, a digital blockchain, store correspondingly modified information components or modified data sets of the modifiable information digitally continuously and dependently on each other so that changes to the data sets can be tracked.

A checking of the corresponding modified information and of the changes made to the information is also possible, for example, by carrying out a comparison with other information carriers within, for example, a computer network. However, in these methods, no additional integration of hardware and/or no additional physical checking of access authorization to the storage system via hardware exists.

### SUMMARY

An aspect of the present invention is to improve upon the prior art.

In an embodiment, the present invention provides a method for storing a modifiable information in a secure manner against falsification via a continuously expandable data volume of superimposed data sets, wherein, a first data set contains the modifiable information, a first modified data set contains a first modified information, and the first data set and the first modified data set are stored in a superimposed manner so as to be trackable in the continuously expandable data volume. The method includes displaying the first data set on an initial display device so as to display a first optical image of the first data set, displaying the first modified data set on a first display device so as to display a first modified optical image of the first modified data set, superimposing the first optical image with the first modified optical image so as to provide a first superimposed optical image, generating a first superimposed hologram of the first superimposed optical image, and storing the first superimposed hologram so as to provide a first stored hologram. The modifiable information being stored in the secure manner against falsification via the first stored hologram.

### BRIEF DESCRIPTION OF THE DRAWINGS

The present invention is described in greater detail below on the basis of embodiments and of the drawings in which:

FIG. 1 shows a schematic representation of an encryption arrangement for generating and storing a hologram; and

FIG. 2 shows a schematic representation of a computer network for comparing correspondingly generated holograms in a computer network.

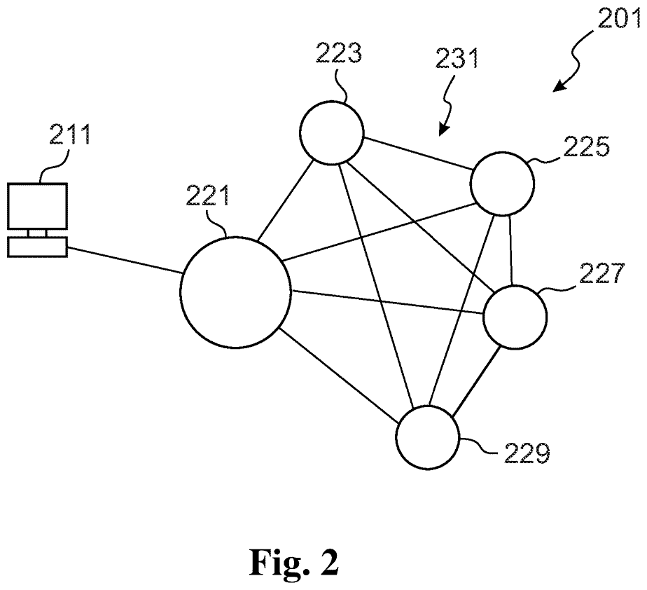

### DETAILED DESCRIPTION

The present invention provides a method for storing modifiable information in a secure manner against falsification via a continuously expandable data volume of superimposed data sets, wherein a first data set contains the modifiable information, and a first modified data set contains first modified information, and the first data set and the first modified data set are stored in a superimposed manner, so that the first data set and the modified data set are stored in a superimposed manner so as to be trackable in the continuously expandable data volume, the method comprising the following steps:
displaying the first data set on an initial display device so that a first optical image of the first data set is displayed;
displaying the first modified data set on a first display device so that a first modified optical image of the first modified data set is displayed;
superimposing the first optical image with the first modified optical image so that a first superimposed optical image is provided;
generating a first hologram of the first superimposed optical image so that a first superimposed hologram of the first superimposed optical image is provided; and
storing the first superimposed hologram so that a first stored hologram is provided,

so that, via the first stored hologram, the modifiable information is stored in a secure manner against falsification.

The core idea of the present invention is to display, superimposed, a superimposed data set formed from a first data set with modifiable information and respective modified data sets with, for example, modified parts of the data set and to then convert the superimposed display into a hologram. Via the hologram of the respective superimposed optical images, the superimposed information is depicted within the hologram and can then be saved. With this approach, in the data thus saved, all previous modifications to the data set are stored in the holographic presentation.

The following terms are explained in this context:

A “method for storing in a secure manner against falsification” describes a method for data processing in which “modifiable information”, i.e., information modifiable or falsifiable, for example, by a user or also by a third party, is stored so that unauthorized falsification by a third party is either avoided and/or manipulation by a third party, in particular by an unauthorized third party, is identifiable from the appearance of the information. Such “information” may in this case be, for example, a computer file in which, for example, financial information is stored, or equally personal data, medical data or other information may be stored, for which a manipulation must be identifiable and/or a corresponding manipulation should be ruled out.

Such information is often saved in a continuous chain of data sets, i.e., an increasing data volume, for example, which in this context is also referred to as a “continuously expandable data volume”. To this end, corresponding “superimposed data sets” are stored, i.e., data sets formed of respective originally provided data items and further added modifications, wherein each modification is saved in a superimposed data set.

A “first data set” in this case contains the modifiable information, i.e., the corresponding original information or starting information, wherein a “first modified data set” and respective subsequent modified data sets contains or contain respective “modified information”, i.e., for example, a modified documentation. The respective data sets are here stored in a “superimposed” manner, i.e., in a data combination, a data addition, a data subtraction or in another manner of superimposition, so that both the original data and correspondingly modified data are contained in the resultant data set of the continuously expandable data volume.

A “display” of the first data set, i.e., a physical projection, presentation or display on an “initial display device”, wherein this initial display device can, for example, be a display or a monitor which contains a corresponding image of the data set, i.e., pixels that are color-coded depending on, for example, data elements. A “first optical image” of the first data set is then displayed as a result.

The first modified data set is furthermore displayed on a first display device, i.e., for example, on a further display, so that a modified optical image of the first modified data set is then displayed.

A “superimposition” describes the physical superimposition of the correspondingly displayed optical images, wherein, for example, a color mixing, a color penetration or a color superimposition or a comparable optical property is generated.

The “generation” of a first hologram then takes place, wherein such a “hologram” represents a method for recording and reconstructing a wave field, wherein the term “hologram” here stands for the method and also for a generated image of the wave field. In contrast to the purely pictorial imaging, the intensity and phase of the wave field are reconstructed in the reconstruction of a corresponding hologram. A larger data volume is thus storable in a hologram than in a correspondingly simple image. It is noted in this regard that a hologram is in particular generated via an illumination of an object with coherent light.

A “superimposed hologram” in this case describes a hologram that is generated from the first optimal image and the modified optical image in accordance with the superimposition described above.

The “storing” of the first superimposed hologram in this case describes the storing of corresponding hologram information on a digital data carrier so that, for example, a file with the information contained in the hologram is generated from the superimposed hologram.

The modifiable information is as a result then stored in the first stored hologram in a secure manner against falsification and in particular contains the information from the first data set and the first modified data set in full.

In order, for example, to also be able to store and track further modifications to the corresponding data, a second modified optical image of a second modified data set with second modified information is displayed on a second display device, a third modified optical image of a third modified data set with third modified information is stored on a third display device, a fourth modified optical image of a fourth modified data set of fourth modified information is displayed on a fourth display device and/or a further modified optical image of a further modified data set of further modified information is displayed on a further display device, and in addition, a superimposition of the first optical image with the respective modified optical images and a generation and storing of a respective hologram of a respective superimposed optical image is performed.

Further modified data sets can consequently be added to the original data correspondingly and thus to the continuously expandable data set or to the continuously expandable data volume, wherein corresponding modifications and, for example, added information are stored in a secure manner against falsification.

In an embodiment of the present invention, the superimposition of the respective optical images can, for example, be carried out via a physical superimposition of the respective display devices, wherein the respective display devices are in particular arranged one behind the other and in particular are partially transparent or are transparent, so that the respective hologram is generated via a common imaging of all display devices.

An additional security level can thus be created via a “physical superimposition”, i.e., for example, the arrangement one behind the other of corresponding displays or semi-transparent displays in a corresponding evaluation device, for example, by enabling a readout and/or a modification of the corresponding data volume only via a correspondingly configured physical device not accessible to third parties.

The respective display device is in this case in particular a digital display, in particular an LCD display.

In an embodiment of the present invention, the respective hologram can, for example, be generated via a, in particular digital, camera, via a laser and/or via a projector. The storing is alternatively or additionally achieved via a film, by via a crystal and/or via a digital data carrier, in particular via a distributed digital data carrier structure.

The use of a digital camera that can record and store, for example, corresponding wave intensities, simplifies the generation of the hologram as compared, for example, to a burning of the hologram into a physical crystal. A burning of the hologram into a crystal may, however, be carried out, for example, via a laser, i.e., via bundled, parallelized light radiation, so that, for example, a further physical encryption level or security level is provided and/or, for example, the modified data set is physically transportable within a crystal. The corresponding information can also be saved on a digital data carrier, i.e., for example, on a USB stick, a solid-state memory or a hard drive.

A “distributed digital data carrier structure” in this context refers, for example, to a network of computers and/or storage media so that, for example, corresponding data volumes for comparison are present in the data carrier structure, also physically separate from one another, for example, at different locations.

In the event of a planned or organized execution of the corresponding modification on the data sets, in order to check whether the originally present data set of the continuously expandable data volume corresponds to a corresponding target, a comparison is performed of the respective previous optical imagings with a comparative imaging, prior to the superimposition of the respective optical imagings, wherein the superimposition of the respective optical imagings and/or the generation of a respective hologram is carried out only if the respective optical imaging matches the comparative imaging.

For example, a respective previous optical imaging can here be compared with comparison information of a comparative imaging stored in a network so that the validity of the previous optical imaging is assured before the data set is modified.

The matching of the corresponding optical imaging with the comparative imaging can here be performed, for example, with corresponding error tolerances so that, for example, in the event of optical falsifications by soiling and/or a defective data transmission, release for modification of the data information is still allowed.

In an embodiment of the present invention, a comparison with a comparative hologram can, for example, be carried out before the respective hologram is saved, wherein the respective hologram is only then saved if the respective hologram matches the comparative hologram.

Comparably to the previous example, the storing can thus only be carried out if the validity of the correspondingly modified information stored in the hologram is provided.

The present invention further provides a method for checking, on the basis of a respective hologram, the anti-falsification security of information stored in a secure manner against falsification via a method according to any one of the previous embodiments, the checking method has the following steps:
scanning the hologram;
comparing the hologram with a respective comparative hologram or a text; and
validating the hologram if the hologram matches the comparative hologram or the text,

so that the anti-falsification security of the information is checked via the hologram.

The core concept of this method is to compare the holograms, produced in particular in accordance with the previously described methods, and thus to check and/or to confirm the validity of the information in comparison to a comparative hologram, for example, a duplicate of the hologram stored in a network or a reference hologram, for example, provided by a network.

The “checking” in this case describes the comparison of the information stored in a secure manner against falsification with a corresponding reference so that the information stored in a secure manner against falsification is, for example, only released in the event of a match.

The “scanning” in this case describes, for example, the recording of the hologram, an imaging of the hologram and/or a digital representation of the hologram in a corresponding apparatus, device and/or, for example, a computer, so that a “comparison” of the hologram, with a respective comparative hologram is performed optically, digitally assisted and/or digitally. A “validation” of the hologram in this context describes the release and/or characterization of the hologram as “valid”, i.e., for example, as matching or sufficiently matching the comparative hologram, so that the authenticity of the information stored in a secure manner against falsification can be assured. A hologram of a previous data set can here also be used in order to be employed as a filter for the data set to be checked.

The present invention also provides a device that is set up to carry out a respective method according to any one of the previously described embodiments for storing modifiable information in a manner secure against falsification and/or for checking the anti-falsification security of information stored in a manner secure against falsification via such a method.

In addition to the previously described methods, the storage may be performed, as is usual for blockchain technology, on a distributed digital data carrier structure, i.e., for example, on so-called “peers”, within a network. This also enables a comparison of data sets to check validity. A standard method such as “proof of authority” or “proof of stack” can be employed for this purpose. An appropriately set up end device issued only to trusted users can likewise have a seal, which is additionally stored holographically and which enables a comparison of authenticity or validity.

In addition to the above described devices, an additional, in particular holographic seal, may also be used to demonstrate authenticity of the corresponding device.

The present invention is explained in greater detail below under reference to an exemplary embodiment as shown in the drawings.

An encryption arrangement 101 has a laser 103, which is directed towards a mirror 105. The mirror directs the laser light 104 generated by the laser through a semi-transparent mirror 111 onto a mirror 107 and further onto a mirror 109. Along an optical path 108, the laser light is then directed through a lens 117 and onto a sequence of LCDs 121, 122, 123 and 124. The laser light interfering with the imagings on the corresponding LCDs then also runs back along the optical path 108 via the mirror 109 and the mirror 107 to the semi-transparent mirror 111 and is directed towards a lens 113 and a lens 115 onto a CCD camera 131. Within the semi-transparent mirror 111, the laser light 104 interferes with corresponding image information from the LCDs so that, with the CCD camera 131, a holographic imaging of the image information displayed on the LCDs 121, 122, 123 and 124 can be recorded.

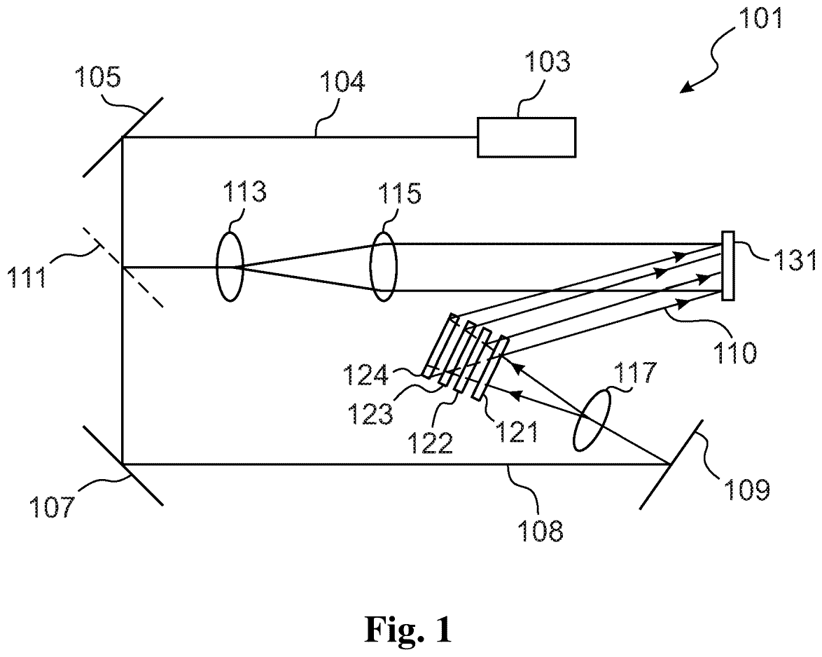

The LCD 121 displays original digital information, for example, the origin of modifiable information. Corresponding modified data sets are then displayed on the LCD 122 and subsequently with further modifications on the LCD 123 and the LCD 124. An imaging of the LCDs 121, 122, 123 and 124 thus shows the original data information as well as three modified levels of the data information, wherein the hologram recorded with the CCD camera 131 stores a sum of all modifications in an image. It is noted that the corresponding merging of the image information with the laser light is used to generate the hologram along an optical path 110. The optical path 110, starting from the LCDs 121, 122, 123, 124 in FIG. 1, is not shown at the correct angle and serves only to illustrate the principle. This optical merging can, for example, be achieved via mirrors, semi-transparent mirrors, prisms or other known optical elements.

A network 201 is used to validate the information. The network 201 comprises a workstation 211 in the form of a personal computer. Peers 221, 223, 225, 227 and 229, connected via network connections 231, are also integrated in the network 201. Should the validity of corresponding information stored in a hologram be queried, the workstation 211 sends the information to the peer 221, wherein the information is furthermore sent to the peers 223, 225, 227 and 229. Only in the event of a matching validation of the information by all peers involved is validity information sent to workstation 211 so that the corresponding hologram, and thus also the integrity of the data information, can be validated.

The present invention is not limited to embodiments described herein; reference should be had to the appended claims.

### LIST OF REFERENCE NUMERALS

101 encryption arrangement
103 laser
104 laser light
105 mirror
107 mirror
108 optical path
109 mirror
110 optical path
111 semi-transparent mirror
113 lens
115 lens
117 lens
121 LCD
122 LCD
123 LCD
124 LCD
131 CCD camera
201 network
211 workstation
221 peer
223 peer
225 peer
227 peer
229 peer
231 network connections

What is claimed is:

1-10. (canceled)

11. A method for storing a modifiable information in a secure manner against falsification via a continuously expandable data volume of superimposed data sets, wherein,
a first data set contains the modifiable information,
a first modified data set contains a first modified information, and
the first data set and the first modified data set are stored in a superimposed manner so as to be trackable in the continuously expandable data volume,
the method comprising:
displaying the first data set on an initial display device so as to display a first optical image of the first data set;
displaying the first modified data set on a first display device so as to display a first modified optical image of the first modified data set;
superimposing the first optical image with the first modified optical image so as to provide a first superimposed optical image;
generating a first superimposed hologram of the first superimposed optical image; and
storing the first superimposed hologram so as to provide a first stored hologram, the modifiable information being stored in the secure manner against falsification via the first stored hologram.

12. The method as recited in claim 11, further comprising:
at least one of:
displaying a second modified optical image of a second modified data set with a second modified information on a second display device;
displaying a third modified optical image of a third modified data set with a third modified information on a third display device;
displaying a fourth modified optical image of a fourth modified data set with a fourth modified information on a fourth display device; and
displaying a further modified optical image of a further modified data set with a further modified information on a further display device;
superimposing the first optical image with at least one of the second modified optical image, the third modified optical image, the fourth modified optical image, and the further modified optical image so as to provide a respective superimposed optical image;
generating a respective hologram of the respective superimposed optical image; and
storing the respective hologram of the respective superimposed optical image.

13. The method as recited in claim 12, wherein the superimposing of the first optical image, the first modified optical image, the second optical image, the third optical image, the fourth optical image, and the further modified optical image is performed via a physical superimposition of the initial display device, the first display device, the second display device, the third display device, the fourth display device, and the further display device, as the case might be.

14. The method as recited in claim 13, wherein the initial display device, the first display device, the second display device, the third display device, the fourth display device, and the further display device, as the case might be, are arranged one behind the other so that the respective hologram is generated via a joint imaging of the initial display device, the first display device, the second display device, the third display device, the fourth display device, and the further display device, as the case might be.

15. The method as recited in claim 14, wherein the initial display device, the first display device, the second display device, the third display device, the fourth display device, and the further display device, as the case might be, are arranged one behind the other and are semi-transparent or transparent.

16. The method as recited in claim 12, wherein the initial display device, the first display device, the second display device, the third display device, the fourth display device, and the further display device is/are a digital display.

17. The method as recited in claim 12, wherein the initial display device, the first display device, the second display device, the third display device, the fourth display device, and the further display device is/are an LCD display.

18. The method as recited in claim 12, wherein at least one of:
the generating of the first superimposed hologram and of the respective hologram is provided via at least one of a camera, a laser and a projector, and
the storing of the first superimposed hologram and of the respective hologram is provided via at least one of a film, a crystal, and a digital data carrier.

19. The method as recited in claim 18, wherein,
the camera is a digital camera, and
the digital data carrier is a distributed digital data carrier structure.

20. The method as recited in claim 12, wherein, prior to superimposing the first optical image with at least one of the second modified optical image, the third modified optical image, the fourth modified optical image, and the further modified optical image so as to provide the respective superimposed optical image, as the case might be, the method further comprises:
comparing a respective previous optical image of the second modified optical image, the third modified optical image, the fourth modified optical image, and the further modified optical image, as the case might be, with a comparative image,
wherein, at least one of,
the superimposing of the first optical image with at least one of the second modified optical image, the third modified optical image, the fourth modified optical image, and the further modified optical image, as the case might be, and
the generating of the respective hologram,
is only then performed if the respective previous optical image matches the comparative image.

21. The method according claim 12, further comprising:
comparing a comparative hologram before the first superimposed hologram and the respective hologram, as the case might be, is saved,
wherein,
first superimposed hologram and the respective hologram, as the case might be, is only then saved if the first superimposed hologram and the respective hologram, as the case might be, matches the comparative hologram.

22. A method for checking, on the basis of a respective hologram, an anti-falsification security of information stored in a secure manner against falsification via the method as recited in claim 12, the method comprising:
scanning the first superimposed hologram or the respective hologram;
comparing the first superimposed hologram or the respective hologram with the respective comparative hologram; and
validating the first superimposed hologram or the respective hologram if the first superimposed hologram or the respective hologram matches the comparative hologram so that the anti-falsification security of the information is checked by via the first superimposed hologram or the respective hologram.

23. A device which is configured to perform the method as recited in claim 22.

24. A device which is configured to perform the method as recited in claim 11.
